(19) United States
(12) Patent Application Publication
(10) Pub. No.: US 2017/0369109 A1
(43) Pub. Date: Dec. 28, 2017

(54) The Urbamobile Transport System and Method of its Exploitation

(71) Applicant: Alexey Fedorovich Khoroshev, Moscow (RU)

(72) Inventor: Alexey Fedorovich Khoroshev, Moscow (RU)

(21) Appl. No.: 15/535,887

(22) PCT Filed: Dec. 21, 2015
(86) PCT No.: PCT/RU2015/000905

§ 371 Date: Jun. 14, 2017

(30) Foreign Application Priority Data
Dec. 22, 2014 (RU) 2014151853

(51) Int. Cl. B62D 47/00; B60P 3/42

(52) U.S. Cl. CPC B62D 47/006; B60P 3/42

(57) ABSTRACT

Related primary to transportation: the device being the Urbamobile Transport System carried out in such a manner that it consists of individual elements performing the functions of a transport mean, with possibility of motion and to be motionless of each element both separately and in contact; the method being the method of exploitation of the transport system, at which forming the transport system individual elements, performing the functions of a transport mean, are moved and placed motionless both separately and in contact. The task is provided, for the first time, to obtain the technical means performing the function of the Urbamobile Transport System, by what the engineering result is achieved that consist in the implementation of the Urbamobile Transport System.

### TECHNICAL FIELD

The claimed inventions refer to the technical field in which the task to obtain, for the first time, the technical means performing the function of the Urbamobile Transport System is actual. The inventions concern primarily such a technical field as the transportation.

### PREVIOUS ENGINEERING LEVEL

Various transport systems and methods of their exploitation are well known. However, as follows from the above, at present the analogues to the claimed inventions do not exist. For the first time, the technical means designed to be the Urbamobile Transport System with the engineering result aiming at the realization of the Urbamobile Transport System is achieved. New engineering solution claimed in this application and forming a uniform invention concept, but not explicitly following for a specialist from the engineering level, presents the Urbamobile Transport System consisting of individual elements performing the functions of a transport mean, each element being able to move or remain motionless both separately and in contact; and the method of exploitation of the transport system that allows individual elements, forming the transport system and performing the functions of a transport mean, to be moved or positioned motionless both separately and in contact. The designated target, being uniform for the claimed inventions, interconnected so that they make up an integrated invention concept, corresponding to the notion of uniformity and, therefore, included into one application is achieved thanks to the arrangement (construction) of the Urbamobile Transport System that is the result of human activity, elements of which exist in the constructive uniformity and functional interconnection, that corresponds to the notion of ‘a facility’ as the object of invention; the designed target is also achieves by corresponding to the notion of ‘method’ as the object of invention, the process of actions over the material object: transport flow, with using of material means: the arrangement of the Urbamobile Transport System that allows individual elements, forming the transport system and performing the functions of a transport mean, to be moved or positioned motionless both separately and in contact.

### DISCLOSURE OF THE INVENTION

The essence of the inventions as the engineering solution is presented below as a combination of fundamental characteristics sufficient to achieve the engineering result, provided by the above inventions—the Urbamobile Transport System and the method of the exploitation of the transport system:

1. The Urbamobile Transport System consisting of individual elements performing the functions of a transport mean, with possibility of motion and to be motionless of each element both separately and in contact.

2. The method of exploitation of the transport system at which forming the transport system individual elements, performing the functions of a transport mean, are moved and placed motionless both separately and in contact.

By the above inventions—the Urbamobile Transport System and the method of the exploitation of the transport system—the task is solved, for the first time, to obtain the technical means performing the function of the Urbamobile Transport System, by what the engineering result is achieved that consist in the implementation of the Urbamobile Transport System.

### BRIEF DESCRIPTION OF FIGURES

Figures are not enclosed.

### EMBODIMENT OF THE INVENTION

The best mode contemplated by the applicant is the Urbamobile Transport System consisting of individual elements performing the functions of a transport mean, with possibility of motion and to be motionless of each element both separately and in contact, realizing the method of exploitation of the transport system that allows individual elements, forming the transport system and performing the functions of a transport mean, to be moved and positioned motionless both separately and in contact; the Urbamobile Transport System provides the ideal Internet interoperability, optimal for any positioning, the possibility to account the data of each element, optimal for any digital technologies, by accounting the data of one point that is the center of a circle, its shape being the outer contour of the projection of such an element on the horizontal surface of the bearing surface; at the same time each individual element from the elements, performing the functions of a transport mean and forming the Urbamobile Transport System, has an encircling protection that allows to move when in contact with something, and can be used for the systematic, fully automated (including remote control) operation, with module elements of passenger and/or freight (or other custom) block, control system, energy supply, frame, transmission, with the use of solar batteries, other systems applying renewable energy sources, energy return and saving systems, and other similar ways of energy saving, two electric engine traction motor-wheels; the outer contour of the projection of such an individual element on the horizontal surface of a bearing surface has the same diameter and the shape of a circle in all the individual elements used in the Urbamobile Transport System, with the possibility of rotation motion of such individual element in the plane of the bearing surface inside such a circle when managed, with the possibility to open and close the passenger and/or freight (or other custom) block inside such a circle, with the possibility of entry and exit of the passengers inside such a circle, of loading and unloading freight inside such a circle.

### INDUSTRIAL USAGE

Is obvious from the description and characteristics of the invention.

1. The Urbamobile Transport System consisting of individual elements performing the functions of a transport mean, with possibility of motion and to be motionless of each element both separately and in contact.

2. The method of exploitation of the transport system at which forming the transport system individual elements, performing the functions of a transport mean, are moved and placed motionless both separately and in contact.
